(19) United States
(12) Patent Application Publication
(10) Pub. No.: US 2012/0173752 A1
(43) Pub. Date: Jul. 5, 2012

(54) Methods for Managing Data Acquisition and Transfer

(75) Inventor: Dannon Erskins, Hemphill, TX (US)

(73) Assignee: KELLOGG BROWN & ROOT LLC, Houston, TX (US)

(21) Appl. No.: 13/337,541

(22) Filed: Dec. 27, 2011

Related U.S. Application Data
(60) Provisional application No. 61/428,694, filed on Dec. 30, 2010.

(51) Int. Cl. G06F 15/16

(52) U.S. Cl. 709/231

(57) ABSTRACT

Systems and methods for data management are provided. A raw data stream can be transmitted from an import provider to a processing module, and the raw data stream can include relevant variables and non-relevant variables. A reference table can be built for the raw data stream. The relevant variables can be selected from within the reference table. The relevant variables can be manipulated to provide output data. The output data can be re-ordered to provide re-ordered output data. The re-ordered output data can be organized into an output table. At least a portion of the re-ordered output data from the output table can be transmitted as one or more output data streams to one or more management tools.

### CROSS-REFERENCE TO RELATED APPLICATION

This application claims the benefit of U.S. Provisional Patent Application No. 61/428,694, filed on Dec. 30, 2010, the content of which is incorporated by reference herein to the extent consistent with the present disclosure.

### BACKGROUND

1. Field

Embodiments described herein generally relate systems and methods for managing the acquisition and transfer of data.

2. Description of the Related Art

Multiple software systems and/or applications are often used to plan, implement, and monitor projects from beginning to completion. Using multiple software systems to manage a given project, however, can be cumbersome. For example, two or more software systems frequently store duplicative information. Moreover, different companies and/or vendors typically design and program their own software systems, and as a result, their software systems oftentimes cannot communicate or interface with other software systems making cross-platform data verification and data sharing difficult and error prone.

There is a need, therefore, for systems and methods for integrating the various sources of data and for managing data acquisition and transfer between the software systems and applications.

### BRIEF DESCRIPTION OF THE DRAWINGS

FIG. 1 depicts an illustrative data acquisition and transfer system, according to one or more embodiments described.

FIG. 2 depicts another illustrative data acquisition and transfer system having a plurality of import providers, according to one or more embodiments described.

FIG. 3 depicts an illustrative processing module for the data acquisition and transfer system depicted in FIG. 1, according to one or more embodiments described.

FIG. 4 depicts another illustrative data acquisition and transfer system having a plurality of management tools, according to one or more embodiments described.

FIG. 5 depicts a representative computer system for implementing at least one data acquisition and transfer system, according to one or more embodiments described.

### DETAILED DESCRIPTION

Systems and methods for data management are provided. A raw data stream including relevant variables and non-relevant variables can be transmitted from an import provider to a processing module. A reference table can be built for the raw data stream. The relevant variables can be selected from within the reference table. The relevant variables can be manipulated to provide output data. The output data can be re-ordered to provide re-ordered output data. The re-ordered output data can be organized into an output table. At least a portion of the re-ordered output data from the output table can be transmitted as one or more output data streams to one or more management tools.

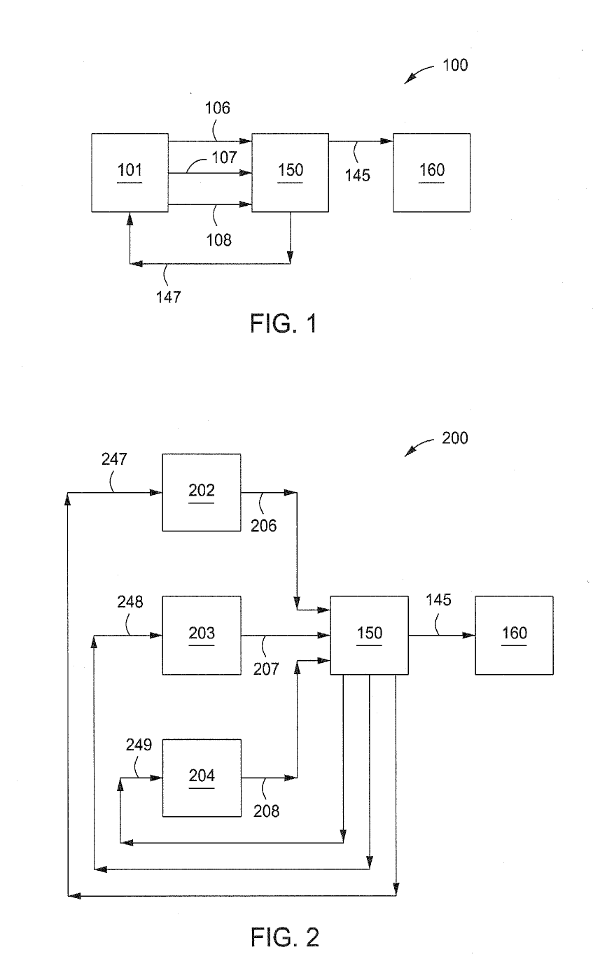

FIG. 1 depicts an illustrative data acquisition and transfer system 100, according to one or more embodiments. The system 100 can implement a method for data acquisition and transfer or data management on at least one machine readable medium, such as a programmed processor. The system 100 can include one or more import providers 101, one or more processing modules 150, and one or more management tools 160. A representative system 100 for performing at least one embodiment of the method for data acquisition and transfer using one or more computers is discussed and described below.

The import provider 101 can be any system, machine, programmed processor, computer program, or source from which a data stream or data files can emanate. For example, the import provider 101 can be, but is not limited to, a work order management system, a change order management system, a planning program, a scheduling program, a time keeping program, a work list database, or any combination thereof. The import provider 101 can also be a source from which manual data input by a user or user input can emanate. For example, the import provider 101 can be coupled to a display device and/or an alphanumeric input device. The import provider 101 can store data locally and/or at a remote location. The import provider 101 can store data using at least one data storage device or memory coupled to at least one processor. The import provider 101 can also include at least one interface adapted to transmit or export data streams (three are shown 106, 107, 108) to the processing module 150 and at least one interface to receive or import data streams (one is shown 147) from the processing module 150.

A plurality of raw data streams 106, 107, 108 can be transmitted from the import provider 101 to the processing module 150. Each of the raw data streams 106, 107, 108 can include, but is not limited to, data regarding a project, labor, work orders, estimated costs, actual costs, projected costs, budgets, tasks, task levels, facilities, cost centers, department codes, deadlines, goals, benchmarks, man-hour predictions, combinations thereof, and the like.

The raw data streams 106, 107, 108 can take a variety of forms. The raw data streams 106, 107, 108 can be or include the same form of data, or the raw data streams 106, 107, 108 can be or include different forms of data with respect to one another. For example the raw data streams 106, 107, 108 can be a continuous stream of data packets, a continuous stream of binary data, one or more text streams, one or more text files, one or more comma separated text files, one or more spreadsheet files, one or more word processing files, one or more Systems Applications and Products (SAP) files, one or more files output from the software package sold under the trade name Microsoft Project, one or more files output from the software package sold under the trade name PASSPORT, one or more files known by the trade name SHAWWARE, one or more files known by the trade name Primavera Project Planner (P3), one or more files known by the trade name Primavera Project Manager (P4 and/or P7), or other file and data formats. The format of the data within the raw data streams 106, 107, 108 can be determined from the provider of the data, from industry sources, and/or from a review of the data within the raw data stream.

The raw data streams 106, 107, 108 can be transmitted either continuously or intermittently. For example, the import provider 101 can be linked to at least one processing module 150 and can continuously transmit one or more raw data streams 106, 107, 108 thereto. In another example, the processing module 150 can import raw data streams 106, 107, 108 on demand, e.g., from a user executed script or command, a machine executed script or command according to a timing regimen in the processing module 150, or both.

The raw data streams 106, 107, 108 can be transmitted from the import provider 101 to the processing module 150 at a rate ranging from a low of about 1/month to a high of about 1,000,000/second. The rate at which the raw data streams 106, 107, 108 can be transmitted can depend at least in part on the size of the files therein, the frequency at which the raw data is updated, and other data transfer factors as would be understood by those skilled in the art.

The raw data streams 106, 107, 108 can be transmitted wirelessly from one machine to another machine, uploaded from a machine readable medium to a machine, or both. For example, the import provider 101 can transmit the raw data streams 106, 107, 108 via wireless communication to the processing module 150. Likewise, the processing module 150 can transmit output data streams 147, 145 via wireless communication to the import provider 101 and the management tool 160, respectively, as discussed in further detail below.

The processing module 150 can process the data from the raw data streams 106, 107, 108 and prepare the processed data for export. The processing module 150 can transmit or export the processed data via at least one first output data stream 145 to at least one management tool 160 and/or via at least one second output data stream 147 back to the import provider 101. Transmitting the first and second output data streams 145, 147 can occur continuously or intermittently. For example, the processing module 150 can continuously transmit both the first output data stream 145 to the management tool 160 and the second output data stream 147 to the import provider 101. In another example, the processing module 150 can transmit the first and second output data streams 145 and 147 on demand to the import provider 101, to the management tool 160, or to both.

The management tool 160 can be any system, machine, programmed processor, computer software program, and/or device capable of processing output data streams 145 received from the processing module 150 and providing a useable output (not shown). For example, the management tool 160 can be a project management software program that uses the output data streams 145 received from the processing module 150 to integrate and/or manipulate program management related data and provide the program management related data to a user to support management of one or more projects. The management tool 160 can include a cost projection module, a work list module, a budget module, a man-hour tally module, a man-hour projection module, a status module, an expenditure module, a change management module, a forecast module, a productivity reporting module, or combinations thereof.

FIG. 2 depicts another illustrative data acquisition and transfer system 200 having a plurality of import providers 202, 203, 204, according to one or more embodiments. Each of the import providers 202, 203, 204 can transmit one or more raw data streams 206, 207, 208. For example, a first import provider 202 can be a time keeping program, a second import provider 203 can be a scheduling program, and a third import provider 204 can be a work order management program. Each of the import providers 202, 203, 204 can transmit a raw data stream 206, 207, 208 related to the same project or different projects, projected/allocated labor and material cost for each project, actual labor and material costs for each project, allocated hours for each project, actual hours charged to each project, project status, and/or any other stored planning and/or activity data.

Data representing the same information can be stored in one or more of the import providers 202, 203, 204. Data can be in the same format or a different format, i.e., data representing the same information can have the same or different graphical or numerical representation across raw data streams 206, 207, 208. Raw data streams 206, 207, 208 from each import provider 202, 203, 204 can be transmitted to the processing module 150. The processing module 150 can then transmit a plurality of output data streams 247, 248, 249 to the plurality of import providers 202, 203, 204 and/or can transmit one or more output data streams 145 to the at least one management tool 160.

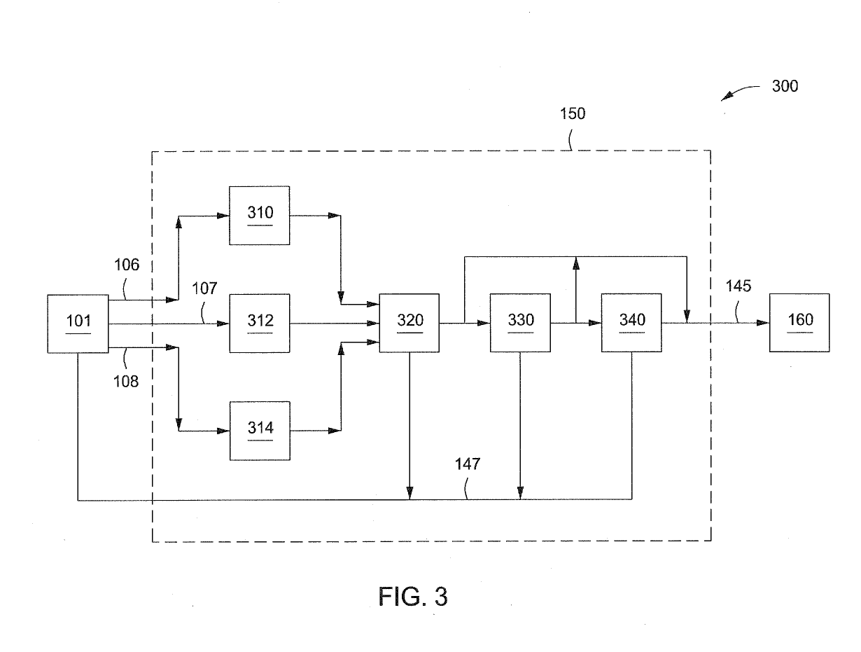

FIG. 3 depicts an illustrative processing module 150 for the data acquisition and transfer system 100 depicted in FIG. 1, according to one or more embodiments. The processing module 150 can include one or more reference tables (three are shown 310, 312, 314), output data 320, re-ordered output data 330, and output data table 340. The one or more reference tables 310, 312, 314 can be built, i.e., include data, from the raw data streams 106, 107, 108 using the known format of the data in the raw data streams 106, 107, 108. Each of the reference tables 310, 312, 314 can be a look-up table into which all data, specific data components, or relevant variables from each of the raw data streams 106, 107, 108 can be recorded along with their associated metadata. Data in the reference tables 310, 312, 314 can be queried and/or sorted for later use in the processing module 150.

Relevant variables can be selected from the data streams 106, 107, 108 and/or from the reference tables 310, 312, 314 based on user needs and/or downstream processing needs. As used herein, the term “relevant variable” is a category of raw data in a data stream 106, 107, 108 that is included in an output stream 145, 147, and/or is required to generate an output stream 145, 147. For example, a user can determine that the relevant variables for a given project can include work order numbers, functional location, estimated costs, and actual costs available from the data stream 106 as recorded in reference table 310; budgets, tasks, task levels, and facilities available from the data stream 107 as recorded in reference table 312; and cost centers, department codes, deadlines, and goals available from the data stream 108 as recorded in reference table 314. In another example, an import provider 101, e.g., a SAP database, can require a user to input a location identification code for all data entered, where the location identification code can include specific location identifiers that relate to other raw data from the import provider 101 and/or is required by an output to the processing module 150.

Relevant variables can be selected from the reference tables 310, 312, 314 by choosing particular data, grouping data, discarding non-relevant variables or unnecessary data, rearranging data, or any combination thereof, from the raw data streams 106, 107, 108 and/or from the reference tables 310, 312, 314. The processing module 150 can associate the relevant variables with a specific project and group the data within each reference table 310, 312, 314 by project. The data can be rearranged according to a time-stamp or a date received. Data also can be discarded if it is duplicative or incorrect. For example, several data streams can all relate to a single work order, each having one or more fields that include the same data as the other data streams relating to that work order. The processing module 150 can discard some or all of that duplicative data related to the single work order.

The relevant variables can be manipulated by the processing module 150 to provide output data 320 for downstream processing, for example, by management tool 160. Manipulation of the relevant variables can include combining reference data with the relevant variables and then formatting the combination. Reference data can be information or data tied or related to a code or identifier in the relevant variable that can be used to populate fields of output data. For example, a certain code in a relevant variable can be identified by the processing module 150 and trigger the processing module 150 to access reference data, e.g., a reference table, to populate fields in the output data 320 with the reference data rather than the code in the relevant variable. Manipulation of the relevant variables can include combining user input data with the relevant variables and then formatting the combination. For example, the relevant data may trigger the processing module 150 to query a user for identifying information that can be added to one or more fields in the output data 320. The output data 320 can be re-structured or re-ordered to provide re-ordered output data 330. The output data 320 can require restructuring or re-ordering for receipt by the management tool 160 or a different import provider 101, i.e., an import provider other than the one from which the data was originally imported. For example, the file format or data structure of a file received by a scheduling program can have a different file format from the file format or data structure received by a timekeeping program. In the example, the data originally from the timekeeping program can be rearranged or re-ordered to match the file format of the scheduling program and then, for example, introduced to the scheduling program as an input. In another example, the output data 320 can include a plurality of cost fields that relate to a single project, where the management tool 160 only can receive a total cost input. In this example, the processing module 150 or another outside module can sum the data in the plurality of cost fields to provide a data field having total cost, as required by the management tool 160.

The re-ordered output data 330 can be organized into an output data table 340, such as a look-up table. The re-ordered output data 330 can be organized in the output data table 340 such that the processing module 150 can access data for future export or manipulation.

The processing module 150 can export at least a portion of the data from the output data 320, the re-ordered output data 330, and/or the data from the output data table 340 to the management tool 160 via the output data stream 145. The processing module 150 can export a portion of the output data allocated for a particular management tool 160 from the output data table 340, where the portion of the output data corresponds to the particular management tool 160 both in format and in information. The processing module 150 can also export at least a portion of the data from the output data 320, the re-ordered output data 330, and/or from the output data table 340 to the import provider 101 via the second output data stream 147. The data exported to the import provider 101 can have the same data and format as the data in the raw data streams 106, 107, 108, or the output data can have different data and/or a different format. The type of output data and the format of the output data in the first and second output data streams 145, 147 can depend, at least in part, on the type of management tool 160 or import provider 101 for which the output data is intended. For example, the first and second output data streams 145, 147 can include data regarding tasks, resources, man-hours, cost, expenditures, budgets, facilities, invoices, cost centers, progress, department codes, or a combination thereof.

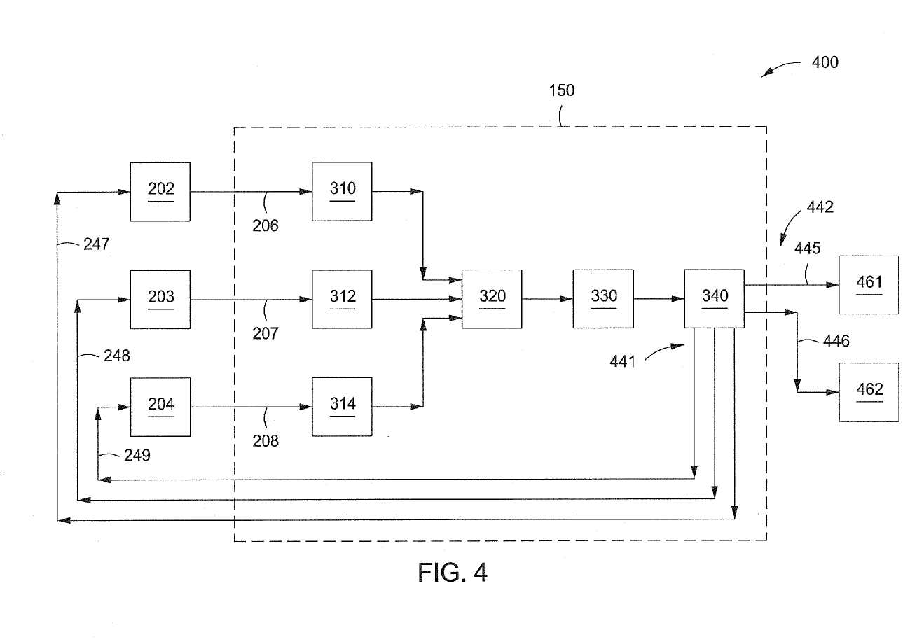

FIG. 4 depicts yet another illustrative data acquisition and transfer system 400 having a plurality of management tools 461, 462, according to one or more embodiments. The system 400 can include the plurality of import providers 202, 203, 204 and the processing module 150, as discussed and described above with reference to FIGS. 2 and 3.

The processing module 150 can export a first plurality of output data streams 441 from the output table 340 to the plurality of import providers 202, 203, 204. For example, a first output stream 247 can transmit at least a portion of the output data to the first import provider 202, a second output stream 248 can transmit at least a portion of the output data to the second import provider 203, and a third output stream 249 can transmit at least a portion of the output data to the third import provider 204. The processing module 150 can also transmit a second plurality of output data streams 442 from the output table 340 to the plurality of management tools 461, 462. For example, the processing module 150 can transmit a first management tool output data stream 445 to a first management tool 461 and can transmit a second management tool output data stream 446 from the output table 340 to a second management tool 462. The output data streams 247, 248, 249 to the plurality of import providers 202, 203, 204 and the output data streams 445, 446 to the plurality of management tools 461, 462 can contain all of the same organized output data, some of the same organized output data, or different organized output data.

Upon implementation of the one or more embodiments, the import providers 202, 203, 204, the processing module 150, and the management tools 461, 462 can cooperate to create and maintain estimates, budgets, commitments, expenditures, cost management, invoice tracking, and/or progress data used in analyzing and reporting total turnaround cost and schedule for one or more projects.

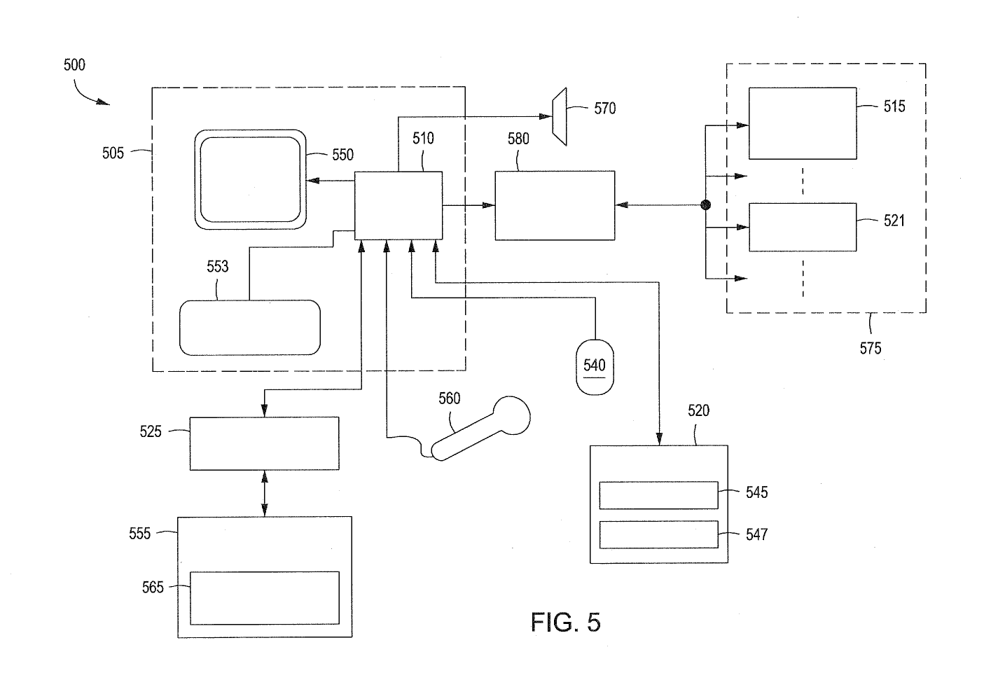

FIG. 5 depicts a representative computer system 500 for implementing at least one data acquisition and transfer system, according to one or more embodiments described. Those skilled in the art will understand that there are many computer system configurations and variations, and it should be understood that the computer system 500 presented in FIG. 5 is not meant to limit the configurations within which the many embodiments described herein can be employed. Any of the plurality of import providers 202, 203, 204, the processing module 150, or the plurality of management tools 461, 462, with reference to FIG. 4 above, can be implemented on the computer system 500 as represented.

The computer system 500 can include a computer 505 and a distributed system 575. The computer 505 can include a central processing unit 510, an input device or keyboard 553, and a monitor 550 on which the data acquisition and transfer system or the method for data acquisition and transfer can be executed, according to one or more embodiments described. The computer 505 can also include a memory 520, as well as additional input and/or output devices. For example, additional input and/or output devices can include a network interface 580, a mouse 540, a microphone 560, a speaker 570, or combinations thereof. The mouse 540, the microphone 560, and the speaker 570 can be used for, among other purposes, universal access and voice recognition or commanding. The monitor 550 can be touch-sensitive and/or stylus operable to operate as an input device as well as a display device. For example, the monitor 550 can be a computer tablet screen capable of receiving inputs from a human hand or a manual or active stylus for entering data and/or commanding the computer 505.

The computer system 505 can interface with external databases, the internet, or the distributed system 575 via the network interface 580. The distributed system 575 can include at least one computer with memory 515 and/or at least one storage device with memory 521. The computer 505 can also interface with removable storage devices 555 via an external interface 525. It should be understood that the terms “network interface” and “external interface” do not indicate a limitation to interfaces that use only Ethernet connections; rather, the terms refer to all possible network interfaces, wired or wireless. For example, the network interface 580 and the external interface 525 can use connection protocols such as a Personal Computer Memory Card International Association (PCMCIA) connection, Peripheral Component Interconnect (PCI) connection, PCI Express connection, Universal Serial Bus (USB) port, IEEE 1394, “FIREWIRE” port, wireless versions of any connection protocols, or other computer interface connection protocol or technology known in the art or that can be available in the future.

It should be understood that even though the computer system 505 is shown as a platform on which the methods described can be performed, the methods and systems described could be performed on any platform where users can interact with Internet sites or service providers. For example, the many and varied embodiments described herein can be used on any device that has computing capability where users interact with remote storage locations, service providers, internet sites, and/or electronic memory capability. These devices can include, but are not limited to, distributed computer networks, hand held electronic devices, laptops, hand held music players, storage devices with memory, cellular phones, smart phones (for example mobile devices running operating systems including, but not limited to, Android™, iPhone® OS, iOS, Palm®, Palm® webOS™, Symbian®, Linux®, Windows®Mobile, Windows® CE, Windows® Phone 7 Series, and Blackberry® OS), or any other device or system upon which a user can store data, execute software, and/or interact with remote storage locations, service providers, and/or internet sites.

The central processing unit 510 can work in concert with one or more of the memory 520, the input device 553, and the output device 550 to perform tasks for the user. For example, a user can create and/or manipulate data or files such as text files, word processing files, spreadsheets, digital music, digital videos, digital photos, contact lists, electronic mail, as well as other electronically stored data or files. The central processing unit 510 can work in concert with the memory 520, the removable storage device 555, the input device 553, and the output device 550 to perform tasks for the user.

Computer programs for implementing data acquisition and transfer can be stored in the memory 520 and/or the removable storage device 555. For example, the memory 520 can store computer programs and enterprise backup images. The memory 520 can be used in concert with the distributed system 575 to perform tasks for the user. For example, the memory 520 can store computer programs while the storage device with memory 521 and/or computer with memory 515 of the distributed system 575 can store enterprise data backup images. Referring to FIGS. 1 and 4, the distributed system 575 can include the management tool 160 or the plurality of management tools 461, 462. The distributed system 575 can also include the import provider 101 or the plurality of import providers 202, 203, 204.

The memory 520, computer with memory 515, and storage device with memory 521 can include any number and combination of memory devices. For example, memory devices can include, without limitation, and for illustrative purposes only: hard drives, disk drives, random access memory, read only memory, registers, cache, magnetic storage, optical memory, electronically erasable programmable read only memory, flash memory, thumb drives, USB drives, SD cards, and any other memory device. Those skilled in the art are familiar with the many variations that can be employed using memory devices, and no limitations should be imposed on the embodiments herein due to memory device configurations and/or algorithm prosecution techniques.

The memory 520 can store at least one operating system (OS) 545 and at least one application 547. The operating system 545 facilitates control and execution of software, such as the application 547 and a virtual storage device agent 565, using the CPU 510. Any of the available operating systems can be used in this manner including WINDOWS, LINUX, Apple OS, UNIX, related server operating system versions of each respective operating system, and the like. The removable storage device 555 can store at least the virtual storage device agent 565 that can assist at least one user in accessing and saving files or data. The files or data can be generated using at least one application, such as the application 547. The memory 520 and removable storage device 555 can be used in concert with computer 505 and the network interface 580 to save and/or access files to/from the distributed system 575, which can operate as a remote storage location. For example, when a user requests access to a file stored on the distributed system 575, the CPU 510 can execute the virtual storage device agent 565 to establish an interface with the distributed system 575 and subsequently retrieve the desired data from the distributed system 575.

The distributed system 575 can be provided by a remote storage provider (not shown). For example, a remote storage provider can provide electronic storage facilities or user storage areas where the user can remotely access and store their data or files using one or more embodiments of the method for data acquisition and transfer discussed and described herein. The remote storage provider can provide their storage facilities for free, for a fee, and/or as part of a broader package of other user services.

The virtual storage device agent 565 can provide a virtual local drive on the removable storage device 555. In one or more embodiments, all of the blocks of the virtual drive can be stored remotely via the network interface 580 to the distributed system 575. In one or more embodiments, all the files on the virtual drive can appear as if they are stored directly on the removable storage device 555 and the user can read, write, modify, add, and/or delete the files as if the files were stored directly on the removable storage device 555. Once the removable storage device 555 is removed from the computer 505, no data from the virtual local drive is left on the computer 505 or in the memory 520.

Some metadata associated with the user data or files stored on the distributed system 575, such as data used with the import provider 101, the plurality of import providers 202, 203, 204, the processing module 150, the management tools 160, and/or the plurality of management tools 461, 462, can be stored on the removable storage device 555. For example, when a user installs the removable storage device 555 in the computer 505, the user can be presented with at least a listing of files or data specific information as if the data was actually stored on the removable storage device 555. For example, when the removable storage device 555 is installed on the computer 505, a folder can be displayed containing the file names of all the files stored on the distributed system 575. The user can select any file from the displayed folder, the virtual storage device agent 565 can establish an interface with the distributed system 575, and the appropriate file or associated blocks can be fetched for use as if the files were stored directly on the removable storage device 555. The metadata associated with the files or data stored on the distributed system 575 can be loaded or updated onto the removable storage device 555 upon establishing an interface with the distributed system 575. For example, the virtual storage device agent 565 can be stored within memory 520, and upon requesting access to the distributed system 575, the metadata can be loaded and/or updated onto the removable storage device 555 such that the user can have up-to-date access to their files stored on the distributed system 575.

Access to the removable storage device 555 and/or the distributed system 575 can be controlled by an access control protocol (not shown). For example, an access control protocol can be employed to protect the user files or data if the removable storage device 555 is lost or stolen. A user can be required to enter a username and password to access the removable storage device 555. The user can be required to enter a separate username and password for access to the distributed system 575, or the username and password can be the same. The user can be required to use individual biometrics, such as a thumbprint or retinal scan, to gain access to the removable storage device 555 and/or distributed system 575. It should be understood that the access control protocol can be employed in any fashion, without limitation, including not requiring any user name or password at all.

In one or more embodiments, every data block can be erasure encoded and stored in one or more distributed systems 575. For example, erasure encoding can ensure that only distributed systems 575 need to be accessible in order to restore a given block of data. The remotely stored files or data can be encrypted, or all of the files or data on the removable storage device 555 can be encrypted.

Embodiments of the present disclosure further relate to any one or more of the following paragraphs:

1. A method for managing data, comprising: transmitting a raw data stream from an import provider to a processing module, wherein the raw data stream comprises relevant and non-relevant variables; building a reference table for the raw data stream; selecting the relevant variables within the reference table; manipulating the relevant variables to provide output data; re-ordering the output data to provide re-ordered output data; organizing the re-ordered output data into an output table; and transmitting at least a portion of the re-ordered output data from the output table as one or more output data streams to one or more management tools.

2. The method of paragraph 1, wherein manipulating the relevant variables comprises: combining reference data with the relevant variables; and formatting the combination of the reference data and the relevant variables.

3. The method according to paragraph 1 or 2, wherein manipulating the relevant variables further comprises adding user input data.

4. The method according to any of paragraphs 1 to 3, wherein the relevant variables comprise one or more categories of data in the raw data stream that are included in at least one of the one or more output data streams, or are required to generate at least one of the one or more output data streams, or both.

5. The method according to any of paragraphs 1 to 4, wherein the import provider comprises at least one of a work order management system, a change order management system, a scheduling program, a time keeping program, and a work list database.

6. The method according to any of paragraphs 1 to 5, wherein transmitting the raw data stream comprises at least one of wirelessly transmitting the raw data stream and uploading the raw data stream from a machine-readable medium.

7. The method according to any of paragraphs 1 to 6, wherein the one or more output data streams comprise at least one of task data, resource data, work order data, man-hour data, cost data, facility data, cost center data, and department code data.

8. The method according to any of paragraphs 1 to 7, wherein the one or more management tools comprise at least one of a cost projection module, a work list module, a budget module, a man-hour tally module, a man-hour projection module, and a productivity reporting module.

9. The method according to any of paragraphs 1 to 8, wherein transmitting the raw data stream and transmitting the one or more output data streams occur continuously.

10. A method for managing data, comprising: importing a plurality of raw data streams from a plurality of import providers into a processing module, the plurality of raw data streams each comprising relevant and non-relevant variables; building a reference table for each raw data stream; identifying the relevant variables within the reference table; manipulating the relevant variables to provide output data; re-ordering the output data to provide re-ordered output data; organizing the re-ordered output data into an output table; and exporting at least a portion of the re-ordered output data from the output table as one or more output data streams to one or more management tools, one or more of the plurality of import providers, or both.

11. The method of paragraph 10, wherein importing the plurality of raw data streams and exporting the one or more output data streams occur continuously.

12. The method according to paragraph 10 or 11, wherein the plurality of import providers comprises at least one of a scheduling program, a change order management system, a work order management system, a time keeping program, a work list database, and user input.

13. A system for data management, comprising: one or more import providers adapted to transmit a raw data stream including relevant and non-relevant variables; a processing module adapted to receive the raw data stream, build a reference table for the raw data stream, identify the relevant variables within the reference table, manipulate the relevant variables to provide output data, re-order the output data to provide re-ordered output data, organize the re-ordered output data into an output table, and export at least a portion of the re-ordered output data as an output data stream; and one or more management tools adapted to receive the output data stream.

14. The system of paragraph 13, wherein reference data is combined with the relevant variables, and the combination of the reference data and the relevant variables is formatted.

15. The system according to paragraph 13 or 14, wherein the relevant variables comprise one or more categories of data in the raw data stream that are included the output data stream, or are required to generate the output data stream, or both.

16. The method according to any of paragraphs 13 to 15, wherein the one or more import providers comprises at least one of a scheduling program, a change order management system, a work order management system, a time keeping program, a work list database, and user input.

17. The method according to any of paragraphs 13 to 16, wherein the raw data stream is transmitted wirelessly or uploaded from a machine-readable medium.

18. The method according to any of paragraphs 13 to 17, wherein the output data stream comprises at least one of task data, resource data, work order data, man-hour data, cost data, facility data, cost center data, and department code data.

19. The method according to any of paragraphs 13 to 18, wherein the one or more management tools comprises at least one of a cost projection module, a work list module, a budget module, a man-hour tally module, a man-hour projection module, and a productivity reporting module.

20. The method according to any of paragraphs 13 to 19, wherein the raw data stream and the output data stream are imported and exported continuously.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present disclosure, other and further embodiments of the disclosure may be devised without departing from the basic scope thereof, and the scope thereof is determined by the claims that follow.

What is claimed is:

1. A method for managing data, comprising:
transmitting a raw data stream from an import provider to a processing module, wherein the raw data stream comprises relevant and non-relevant variables;
building a reference table for the raw data stream;
selecting the relevant variables within the reference table;
manipulating the relevant variables to provide output data;
re-ordering the output data to provide re-ordered output data;
organizing the re-ordered output data into an output table; and
transmitting at least a portion of the re-ordered output data from the output table as one or more output data streams to one or more management tools.

2. The method of claim 1, wherein manipulating the relevant variables comprises:
combining reference data with the relevant variables; and
formatting the combination of the reference data and the relevant variables.

3. The method of claim 1, wherein manipulating the relevant variables further comprises adding user input data.

4. The method of claim 1, wherein the relevant variables comprise one or more categories of data in the raw data stream that are included in at least one of the one or more output data streams, or are required to generate at least one of the one or more output data streams, or both.

5. The method of claim 1, wherein the import provider comprises at least one of a work order management system, a change order management system, a scheduling program, a time keeping program, and a work list database.

6. The method of claim 1, wherein transmitting the raw data stream comprises at least one of wirelessly transmitting the raw data stream and uploading the raw data stream from a machine-readable medium.

7. The method of claim 1, wherein the one or more output data streams comprise at least one of task data, resource data, work order data, man-hour data, cost data, facility data, cost center data, and department code data.

8. The method of claim 1, wherein the one or more management tools comprise at least one of a cost projection module, a work list module, a budget module, a man-hour tally module, a man-hour projection module, and a productivity reporting module.

9. The method of claim 1, wherein transmitting the raw data stream and transmitting the one or more output data streams occur continuously.

10. A method for managing data, comprising:
importing a plurality of raw data streams from a plurality of import providers into a processing module, the plurality of raw data streams each comprising relevant and non-relevant variables;
building a reference table for each raw data stream;
identifying the relevant variables within the reference table;
manipulating the relevant variables to provide output data;
re-ordering the output data to provide re-ordered output data;
organizing the re-ordered output data into an output table; and
exporting at least a portion of the re-ordered output data from the output table as one or more output data streams to one or more management tools, one or more of the plurality of import providers, or both.

11. The method of claim 10, wherein importing the plurality of raw data streams and exporting the one or more output data streams occur continuously.

12. The method of claim 10, wherein the plurality of import providers comprises at least one of a scheduling program, a change order management system, a work order management system, a time keeping program, a work list database, and user input.

13. A system for data management, comprising:
one or more import providers adapted to transmit a raw data stream including relevant and non-relevant variables;
a processing module adapted to receive the raw data stream, build a reference table for the raw data stream, identify the relevant variables within the reference table, manipulate the relevant variables to provide output data, re-order the output data to provide re-ordered output data, organize the re-ordered output data into an output table, and export at least a portion of the re-ordered output data as an output data stream; and
one or more management tools adapted to receive the output data stream.

14. The system of claim 13, wherein reference data is combined with the relevant variables, and the combination of the reference data and the relevant variables is formatted.

15. The system of claim 13, wherein the relevant variables comprise one or more categories of data in the raw data stream that are included the output data stream, or are required to generate the output data stream, or both.

16. The system of claim 13, wherein the one or more import providers comprises at least one of a scheduling program, a change order management system, a work order management system, a time keeping program, a work list database, and user input.

17. The system of claim 13, wherein the raw data stream is transmitted wirelessly or uploaded from a machine-readable medium.

18. The system of claim 13, wherein the output data stream comprises at least one of task data, resource data, work order data, man-hour data, cost data, facility data, cost center data, and department code data.

19. The system of claim 13, wherein the one or more management tools comprises at least one of a cost projection module, a work list module, a budget module, a man-hour tally module, a man-hour projection module, and a productivity reporting module.

20. The system of claim 13, wherein the raw data stream and the output data stream are imported and exported continuously.
